(19) United States
(12) Patent Application Publication
(10) Pub. No.: US 2002/0134059 A1
(43) Pub. Date: Sep. 26, 2002

(54) Cyclone dust- collecting apparatus for vacuum cleaner

(76) Inventor: Jang-keun Oh, Kwangju-city (KR)

Correspondence Address: Judson K. Champlin, WESTMAN CHAMPLIN & KELLY, International Centre, Suite 1600, 900 South Second Avenue, Minneapolis, MN, 55402-3319, US

(21) Appl. No.: 09/998,884

(22) Filed: Oct. 31, 2001

(30) Foreign Application Priority Data
Mar. 24, 2001 (KR) 2001-15417

(51) Int. Cl. B01D 45/18

(52) U.S. Cl. 55/337; 55/429; 15/353; 55/467

(57) ABSTRACT

A cyclone dust-collecting apparatus of a vacuum cleaner includes a cyclone body installed at an extension hose for generating air current of vortex from incoming air, a grill for filtering back drafting current of the air current of vortex, and a cyclone cover including a partly blocked plate, which is placed to correspond to the grill, a filth passage for guiding filth to a filth-collecting container, and a first connection member for connecting the cyclone body with the filth-collecting container. The filth-collecting container has second connection member for connecting with the cyclone cover. Accordingly, it can be prevented a grill from being blocked by back drafting of piled filth in the filth-collecting container regardless of the position of a user. When the user eliminates collected filth, breakage of a grill or falling down of the filth clung to the grill, can also be prevented.

The present application is based on and claims the benefit of Korean patent application Ser. No. 2001-15417, filed Mar. 24, 2001, the content of which is hereby incorporated by reference in its entirety.

### BACKGROUND OF THE INVENTION

1. Field of the Invention

The present invention relates to a vacuum cleaner and, more particularly, to a cyclone dust-collecting apparatus for a vacuum cleaner, which collects primarily big filth that is drawn in through a suction port of the vacuum cleaner.

2. Description of the Related Art

A cyclone dust-collecting apparatus has been used in the field of industry for a long time as an apparatus for separating particles in fluid by using centrifugal force, due to its simple structure and the advantage of being durable under the condition of high temperature and high pressure. Moreover, there is a vacuum cleaner having a cyclone dust-collecting apparatus. The changing interval of the paper filter of such vacuum cleaner can be extended, since relatively big filth like tissue, vinyl or hair, which is drawn into the vacuum cleaner via a suction port is prevented from being collected in the paper filter.

FIG. 1 is a perspective view of a vacuum cleaner with a conventional cyclone dust-collecting apparatus. From FIG. 1, a vacuum cleaner having a conventional cyclone dust-collecting comprises a suction brush 4 for drawing filth, an extension hose 3, which connects the suction brush 4 with a body 1 of the vacuum cleaner, a flexible hose 2, a paper filter 7 for collecting filth, and a motor part (not shown) that generates suction power. A cyclone dust-collecting apparatus 10, which is for collecting relatively big particles, is attached to one end of the extension hose 3.

The suction brush 4 draws filth from the out side. The air containing all types of filth, which is drawn into the vacuum cleaner via the suction brush 4, flows into a cyclone cover 12. After being drawn from the out side, the air forms vortex in the cyclone cover 12. Simultaneously, all types of relatively big filth such as tissue, vinyl, and hair and so on in the air are separated by centrifugal force of the vortex. Separated particles of the big filth are piled in the cyclone cover 12. The cleaned air flows upward again from the bottom of the cyclone cover 12, and is exhausted to the body 1 of the vacuum cleaner via a grill 11 of the cyclone dust-collecting apparatus and the flexible hose 2.

However, the described conventional vacuum cleaner including the cyclone dust-collecting apparatus has some disadvantages. If the suction brush 4 is lifted higher than the extension hose 3 for cleaning filth that is at a high place, or if a user tilt or overturns the cyclone dust-collecting apparatus unconsciously, piled filth in the cyclone cover 12, such as tissue, vinyl, and hair could be flown backward to the grill 11 of the cyclone dust-collecting apparatus. Since the back flow of the filth clogs the grill 11 of the cyclone dust-collecting apparatus, and it decreases cleaning efficiency or causes an incapable movement, the back flow of the filth should be prevented.

In addition, when filth is fully piled in the cyclone cover 12, the cyclone cover 12 should be separated from the body for removing the filth in the cyclone cover 12. This also pollutes the around because the filth that is clung to the grill 11 is fallen as the grill is exposed, and another possibility is that the grill 11 could be broken if it is not treated properly.

### SUMMARY OF THE INVENTION

The present invention has been made to overcome the above-mentioned problems of the related art. According to the present invention, it can provide a cyclone dust-collecting apparatus of a vacuum cleaner that prevents piled filth from back drafting and blocking a grill because of the change of a position, and filth that is clung to the grill is prevented from falling down from the grill and the present invention also reduces the possibility of breaking the grill when a user throws collected filth.

The above object is accomplished by constructing the cyclone dust-collecting apparatus at an extended hose of a vacuum cleaner. The cyclone dust-collecting apparatus having a cyclone body that generates the air current of vortex from incoming air and includes a grill that filters the air current, which drafts backward to the above air current of vortex. The cyclone dust-collecting apparatus that has a blocked plate at the lower portion and a filth leading passage, which leads drawn filth to a filth-collecting container, is connected to the cyclone body. Also, it includes a cyclone cover housing the first connection members for being connected with a filth-collecting container, and the filth-collecting container has the second connection members corresponding to the first connection members.

The bottom plate of the cyclone cover is partly blocked at the opposite side of the grill, and has a through hole at the side of a filth leading passage. The first connection members are constructed for connecting the filth-collecting container with the cyclone cover. It is advisable that the first connection members are formed as two connection recesses at each side of the lower portion of the cyclone cover. In addition, it is preferable that the second connection members of the filth-collecting container have two connection protrusions that correspond to each of the first connection members at the upper portion of the filth-collecting container.

### BRIEF DESCRIPTION OF THE DRAWINGS

Reference may now be made to the accompanying drawings for a better understanding of the invention, both as to its described objection and feature, with the illustration showing a preferred embodiment, but being only exemplary, and in which:

FIG. 1 is a perspective view of a vacuum cleaner having a conventional cyclone dust-collecting apparatus;

FIG. 2 is an exploded perspective view of a cyclone dust-collecting apparatus in accordance with a preferred embodiment of the present invention;

FIG. 3 is an exploded end view illustrating the connection between the cyclone cover and the filth-collecting container of FIG. 2;

FIG. 4 is a bottom view of the cyclone cover of FIG. 2; and

FIG. 5 is an end view schematically illustrating how the cyclone dust-collecting apparatus of FIG. 2 is connected.

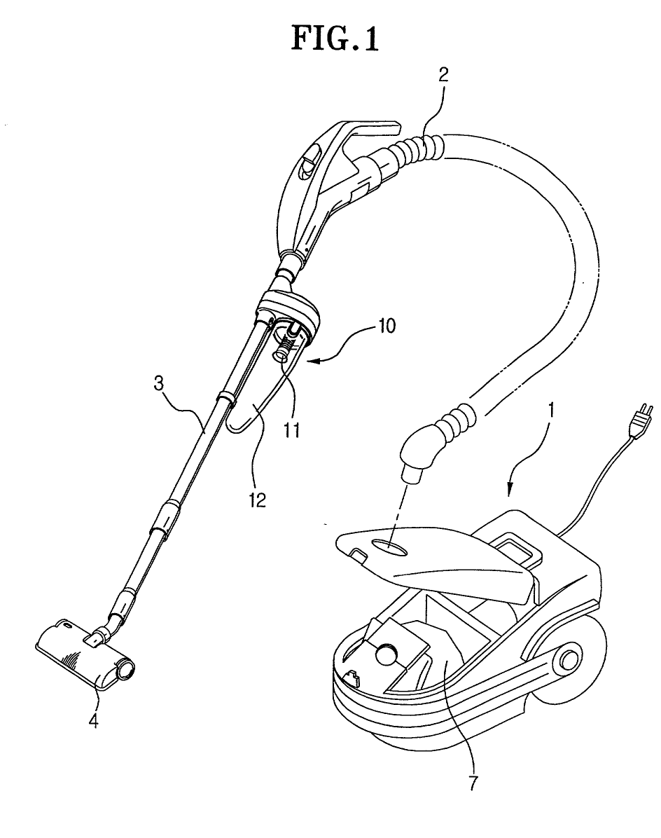

### DETAILED DESCRIPTION OF PREFERRED EMBODIMENT

The present invention will be explained in more detail by reference to the following detailed description and the drawing.

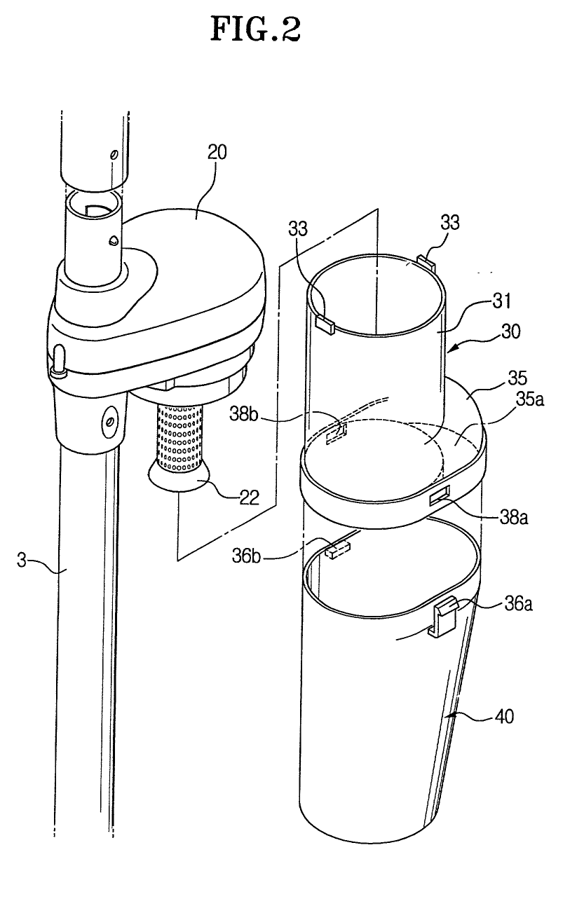

FIG. 2 is an exploded perspective view illustrating the cyclone dust-collecting apparatus of a vacuum cleaner according to the preferred embodiment of the present invention.

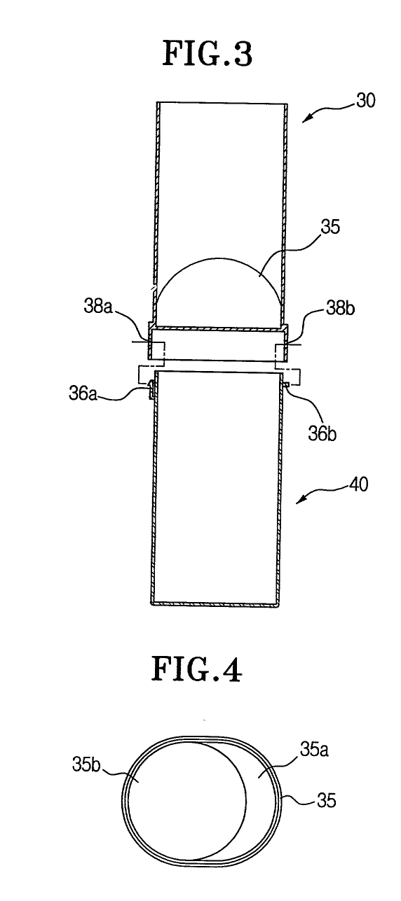

FIG. 3 is an exploded end view of FIG. 2 showing the connection of the cyclone cover and the filth-collecting container. And FIG. 4 is a bottom view of the cyclone cover of FIG. 2.

Referring to FIG. 2 through 4, the cyclone dust-collecting apparatus of a vacuum cleaner includes a cyclone body 20, a cyclone cover 30, and a filth-collecting container 40.

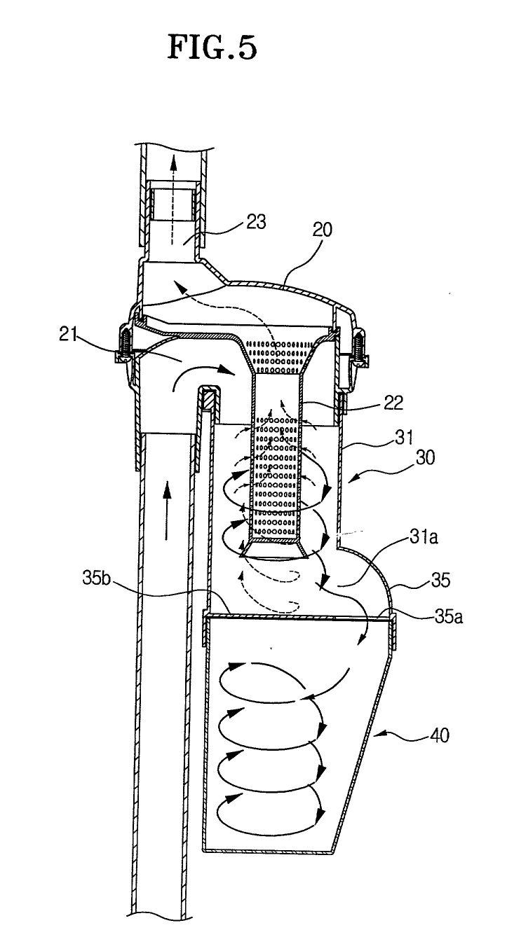

The cyclone body 20 includes an inflow passage 21 (refer to FIG. 5) that draws air from a brush (not shown) diagonally, a grill 22 that filters the air, which is reflected from the cyclone cover 30, and an air exhausting passage 23 (refer to FIG. 5) that guides the air to the body of the vacuum cleaner via the grill 22. The cyclone body 20 is connected to the extension hose 3 of a vacuum cleaner.

The cyclone cover 30 includes a cover body 31 and a filth passage 35 extended from the cover body 31. The cover body 31 guides the air that is drawn diagonally into via the inflow passage 21 of the cyclone body 20, into an air current of vortex. It is advisable that the cover body 31 is constructed as a cylinder type to induce the air current of vortex easily. The upper portion of the cover body 31 is open, the cover body 31 has at least two connecting protrusions 33 protruding from the upper portion of the cover body 31, to be connected to the cyclone body 20.

The bottom surface of the cyclone cover 30 is extended to the side direction of the cover body 31 from the both ends in diameter to the direction of a tangent line with the same length and the same direction as well. And the bottom surface of the cyclone body 30 is formed at the end of the extended line forming a circular arc with some degree of curvature. The degree of the circular arc that is formed at the end of the extended line should be greater than the degree of curvature of the cover body 31 so that the rotational force of the air current of vortex can be easily reduced. Besides the features described above, the bottom surface of the cyclone cover 30 includes a blocked plate 35b, which is blocked partly corresponding to the grill 22. Moreover, there is a space 35a corresponding to the filth passage 35. It is preferable that the blocked plate 35b of the bottom of the cyclone cover 30 to be circled as the cover body 31, for easy exhausting of filth to the filth-collecting container 40 via the space 35a. Another purpose of making the blocked plate 35b circled is to prevent the filth from back flowing even when a user inclines the cyclone dust-collecting apparatus 10.

The filth passage 35 is extended from lower portion of the cyclone cover 30 forming the part of a sphere contacting with the out side of the cover body 31. The cover body 31 has a space 31a defined from the connecting part of the cover body 31 and the filth passage 35 to the blocked plate 35b at the bottom of the cyclone cover 30 for guiding filth to the filth passage 35.

The lower portion of the cyclone cover 30 is extended to a predetermined length to receive the filth-collecting container 40. There are first connection member 38a and 38b formed at the lower portion of the extended cyclone cover 30 for connecting and supporting the filth-collecting container 40.

Some part of the filth leading passage 35 is formed of a convex sphere relating to the lower portion of the extended line to a side direction of the cyclone cover 30 contacting the out side of the cover body 31. The space 35a is formed between the inner circumference of the filth passage 35 at the lower portion of the cyclone cover 30 and the blocked bottom plate of the cover body 31 for guiding filth, which is separated inside of the cyclone cover 30, to the filth-collecting container 40.

The filth that is drawn into through the filth passage 35 of the cyclone cover 30 is piled in the filth-collecting container 40. The upper portion of the filth-collecting container 40 is formed to correspond and be inserted into the extended part of the lower portion of the cyclone cover 30. Moreover, the filth-collecting container 40 comprises second connection member 36a and 36b, which are connected to the first connection member 38a and 38b and supported to prevent the filth-collecting container 40 from falling out from the cyclone cover 30, after the filth-collecting container 40 being inserted into the lower portion of the cyclone cover 30.

It is preferable that the shape of the filth-collecting container 40, which corresponds to the filth passage 35 of the cyclone cover 30, is constructed to be narrower downwardly for easy rotation and falling down of the filth that is drawn into via the space 35a. In this case, the shape of the filth-collecting container 40 could be constructed such that only the filth passage 35 side is declined, or the both sides of the filth-collecting container 40 could be declined to be symmetrical when the filth-collecting container 40 is seen from a sectional side view.

The second connection member 36a and 36b are positioned to correspond the first connection member 38a and 38b to be connected with the first connection member 38a and 38b, which are placed at the lower portion of the cyclone cover 30. In the preferred embodiment of the present invention, the first connection member 38a and 38b are formed to have a pair of connection recesses. The second connection member 36a and 36b consist of a pair of connection protrusions: a first connection protrusion 36b and a second connection protrusion 36a. The first connection protrusion 36b is inserted into a connection groove that is formed in the cyclone cover 30. The second connection protrusion 36a is formed on a flexible member and inserted into the other connection groove in the cyclone cover 30. The second connection protrusion 36a can be separated from connection with the cyclone cover 30 by adding some pressure to the flexible member.

However, the first connection member 38a and 38b and the second connection member 36a and 36b could be realized into various types without being limited by the described features above. For example, there could be multiple first connection members and the second connection members, which correspond to the number of the first connection members.

FIG. 5 is an end view schematically showing the cyclone dust-collecting apparatus of FIG. 2. Description about the operation of the cyclone dust-collecting apparatus of the present invention will be followed referring to FIG. 5.

The air containing filth that is drawn via the brush (not shown) is drawn into the cyclone cover 30 via the inflow passage 21 of the cyclone body 20. The air is drawn into via the inflow passage 21, slightly declined at a predetermined slope, the air is drawn into the cyclone cover 30 into a current of vortex. The air that is drawn into the cyclone cover 30 falls down rotating around the circumference of the grill 22. At the same time, filth with big particles contained in the air falls down rotating following the air current of vortex. When the filth with big particles that is included in the incoming and falling air reaches the lower portion of the cyclone cover 30, the filth is guided to the filth passage 35 via the through hole 31a by centrifugal force.

The filth with big particles, which is guided to the filth passage 35 is exhausted to the filth-collecting container 40 following the air current of vortex via the space 35a at the lower portion of the filth passage 35. While filth with big particles is exhausted to the filth-collecting container 40 and rotates in the air current of vortex, the filth cannot make its way to upward due to the presence of the blocked plate 35b at the lower portion of the cyclone cover 30. Instead, the filth rotates only inside of the filth-collecting container 40.

In the cyclone cover 30, the filth with big particles is guided to the filth passage 35 and the air current of vortex rises after bumping to the blocked plate 35b at the lower portion of the cyclone cover 30. And the air current of vortex rotating inside of the filth-collecting container 40 rises after bumping to the bottom of the filth-collecting container 40. However, filth with big particles is piled in the filth-collecting container 40 because the filth cannot rise because of the blocked plate 35b at the lower portion of the cyclone cover 30. The air current of vortex rises from the filth-collecting container 40 leaving filth with big particles in the filth-collecting container 40 and is again drawn into the cyclone cover 30 via the space 35a. The air current that rises after bumping to the blocked plate 35b and another air current that rises from the filth-collecting container 40 is drawn into the grill 22.

The grill 22 filters the air after the filth with big particles is exhausted to the filth-collecting container 40 and other air current rising after reflecting from the blocked plate 35b of the cyclone cover 30. Through the grill 22, these air currents are exhausted to the exhausting passage 23. The uprising air currents that are filtered through the grill 22 contain filth with small particles. The uprising air current is exhausted to the body of a vacuum cleaner (not shown) via the exhausting passage 23.

From now on, how to remove the filth that is piled in the filth-collecting container 40 will be explained. Referring to FIGS. 2 and 3, the filth-collecting container 40 is supported by the second connection member 36a and 36b of the filth-collecting container 40 connected to the first connection member 38a and 38b of the cyclone cover 30.

In the embodiment of the present cyclone dust-collecting apparatus, the first connection member 38a and 38b are formed to have a pair of connection recesses, and the second connection member 36a and 36b are formed to have the first connection protrusion 36b and the second connection protrusion 36a. The first connection protrusion 36b is supported by being inserted into one of the connection recesses of the cyclone cover 30. The second connection protrusion 36a is formed on a flexible member and inserted into the other connection groove of the cyclone cover 30. The second connection protrusion 36a is constructed to be detachable from connection with the cyclone cover 30 by pressing the flexible member.

When the filth-collecting container 40 is piled up, a user separates the second connection protrusion 36a from the connection groove 38a in the cyclone cover 30, by pushing and pulling out the flexible member having the detachable second connection protrusion 36a. Then, the user pulls out the first connection protrusion 36b from the corresponding connection groove 38b of the first connection member by pulling down the filth-collecting container 40 with a slight tilt. After eliminating the filth in the filth-collecting container 40, the user reconnects the filth-collecting container 40 to the cyclone cover 30 as follows. Firstly, the user inserts the connection protrusion 36b of the second connection member of the filth-collecting container 40 into the corresponding connection groove 38b of the first connection member. After that, the user inserts the connection protrusion 36a of the second connection member into the connection groove 38a of the first connection member. It has been only explained here that the second connection member 36a and 36b are only connected to the each corresponding connection groove of the first connection member 38a and 38b. However, if the filth-collecting container 40 has the same planes of symmetry and if the first connection member 38a and 38b and the second connection member 36a and 36b are placed at the center of the both sides, the second connection member 36a and 36b could be connected to the first connection member 38a and 38b regardless of the connecting direction.

In the embodiment of cyclone dust-collecting apparatus according to the present invention, the filth leading passage 35 of the cyclone cover 30 has been explained as to be part of a sphere. However, without being restricted to the sphere type, the filth leading passage 35 can be constructed to have another shape such as elbow, etc.

In addition, the variation can be adapted to the connection members as well. The first connection member 38a and 38b are formed to have two connection recesses and the second connection member is formed to have two corresponding connection protrusions. Both connection members can be constructed with various types without being restricted by the above feature. For example, the second connection member could be constructed as ribs protruding from the upper portion of the filth-collecting container 40 and the first connection member could be constructed as tightening means for easy tightening and loosening.

The filth-collecting container is constructed as an independent member, which is attachable to and detachable from the cyclone cover. Thus, accidental breakage of the grill can be prevented when a user throw out the filth piled in the filth-collecting container, since there is no necessity of separating the cyclone cover from the cyclone body.

As described above, the present invention can provide several improved features of a cyclone dust-collecting apparatus of vacuum cleaner. Firstly, the filth plied in the filth-collecting container of the dust-collecting apparatus is prevented from back flowing and blocking the grill when a user uses the vacuum cleaner in any position. Secondly, when throwing out the piled filth, dust that is clung to the grill is prevented from falling down. Also the grill is protected not to be broken.

Although the preferred embodiment of the present invention has been described, it will be understood by those skilled in the art that the present invention should not be limited to the described preferred embodiment. Various changes and modifications can be made within the spirit and scope of the present invention as defined by the appended claims.

What is claimed is:

1. A cyclone dust-collecting apparatus of a vacuum cleaner, comprising:
a cyclone body installed at an extension hose for generating air current of vortex from incoming air;
a grill for filtering back drafting current of the air current of vortex; and
a cyclone cover including a partly blocked plate, which is placed to correspond to the grill, a filth passage for guiding filth to a filth-collecting container, and a first connection member for connecting the cyclone body and the filth-collecting container;
wherein the filth-collecting container has second connection member for connecting with the cyclone cover.

2. The cyclone dust-collecting apparatus of claim 1, wherein the first connection member comprises two connection recesses formed on the lower portion of the cyclone cover opposed to each other.

3. The cyclone dust-collecting apparatus of claim 2, wherein the second connection members have two connection protrusions protruding from a upper portion of the filth-collecting container corresponding to the connection recesses of the first connection member.

4. The cyclone dust-vacuum apparatus of claim 3, wherein said second connection member comprises a first connection protrusion supported by being inserted into one of said connection recesses of the cyclone cover, and a second connection protrusion formed on a flexible member and inserted into the other connection groove, and separated from said cyclone cover by adding pressure to said flexible member.
